(19) United States
(12) Patent Application Publication
(10) Pub. No.: US 2020/0221630 A1
(43) Pub. Date: Jul. 16, 2020

(54) AGRICULTURAL IMPLEMENT WITH OBJECT COLLISION MARKING CAPABILITY

(71) Applicant: CNH Industrial Canada, Ltd., Saskatoon (CA)

(72) Inventor: Barry M. Pomedli, Saskatoon (CA)

(73) Assignee: CNH Industrial Canada, Ltd., Saskatoon (CA)

(21) Appl. No.: 16/245,550

(22) Filed: Jan. 11, 2019

(51) Int. Cl. A01B 69/04; A01B 79/00; A01D 41/127; G05D 1/00

(52) U.S. Cl. CPC A01B 69/008; G05D 1/0088; A01D 41/1278; A01B 79/005

(57) ABSTRACT

An agricultural implement includes: a frame; a location sensor coupled to the frame; a plurality of shank assemblies carried by the frame that each include a shank and a trip sensor associated with the shank; and a controller operatively coupled to a memory storing a field map therein, the location sensor, and the trip sensor of each of the shank assemblies. The controller receives an output trip signal from a trip sensor; determines a specific shank associated with the trip sensor that output the trip signal; determines a separation distance between the specific shank and a reference; determines a current location based on a current location signal from the location sensor; determines a field object location based on the determined separation distance and the determined current location; and outputs an update signal to the memory to designate the field object location on the stored field map.

### BACKGROUND OF THE INVENTION

The present invention relates to agricultural implements, and, more particularly, to agricultural tillage implements with shank assemblies.

Farmers utilize a wide variety of agricultural implements to prepare soil for planting and subsequently depositing seeds in the prepared soil. Such implements generally include multiple shank assemblies with a shank that carries a ground working tool, such as a knife, to prepare the soil. One particular type of implement that may be used is referred to as a “seeder,” which digs trenches in the soil and deposits seeds in the trenches.

While traveling through a field, the ground working tools may encounter various objects that can cause damage, such as rocks, impacted clods of soil, etc. Operators generally try to avoid collisions between the ground working tools and such objects because one or more damaged ground working tools can cause a significant detrimental effect on planting. Further, replacing a damaged ground working tool and/or shank requires implement downtime while the damaged components are removed and replaced.

What is needed in the art is an agricultural implement that can assist an operator in avoiding damaging collisions between ground working tools of the implement and objects in a field.

### SUMMARY OF THE INVENTION

The present disclosure provides a controller for an agricultural implement that can update a field map to designate a field object location in the field map based off a separation distance between a tripped shank and a reference.

In some embodiments provided in accordance with the present disclosure, an agricultural implement includes: a frame; a location sensor coupled to the frame and configured to output a current location signal; a plurality of shank assemblies carried by the frame that each include a shank and a trip sensor associated with the shank and configured to output a trip signal when the shank collides with an object; and a controller operatively coupled to a memory storing a field map therein, the location sensor, and the trip sensor of each of the shank assemblies. The controller is configured to: receive the output trip signal from the trip sensor of at least one of the shank assemblies; determine a specific shank associated with the trip sensor that output the trip signal; determine at least one separation distance between the specific shank and a reference; determine a current location based on the current location signal; determine a field object location based on the determined at least one separation distance and the determined current location; and output an update signal to the memory to designate the field object location on the stored field map.

In some embodiments, a method of updating a field map stored in a memory is provided. The method is performed by a controller and includes: receiving an output trip signal from a trip sensor associated with at least one shank of an agricultural implement, the trip signal being output when the at least one shank collides with an object; determining a specific shank associated with the trip sensor that output the trip signal; determining at least one separation distance between the specific shank and a reference; receiving a current location signal from a location sensor; determining a current location based on the received current location signal; determining a field object location based on the determined at least one separation distance and the determined current location; and outputting an update signal to the memory to designate the field object location on the stored field map.

One possible advantage that may be realized by exemplary embodiments disclosed herein is that the location of an object in a field can be determined using the location of a tripped shank, allowing for accurate designation of the object in the stored field map.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a top view of an exemplary embodiment of an agricultural implement provided in accordance with the present disclosure that is hitched to a towing vehicle;

FIG. 2 is an illustration of a touchscreen display showing an exemplary embodiment of a field map stored in a memory according to the present disclosure;

FIG. 3 is a top view of the agricultural implement illustrated in FIG. 1 when a shank of the implement collides with a rock and a reference is a travel axis of the implement;

FIG. 4 is an illustration of the field map illustrated in FIG. 2 after the memory storing the field map receives an update signal to designate a field object location on the stored field map;

FIG. 5 is a top view of the agricultural implement illustrated in FIG. 1 when a shank of the implement collides with a rock and a reference is a reference point; and

FIG. 6 is a flow chart illustrating an exemplary embodiment of a method of updating a field map stored in a memory that is provided in accordance with the present disclosure.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

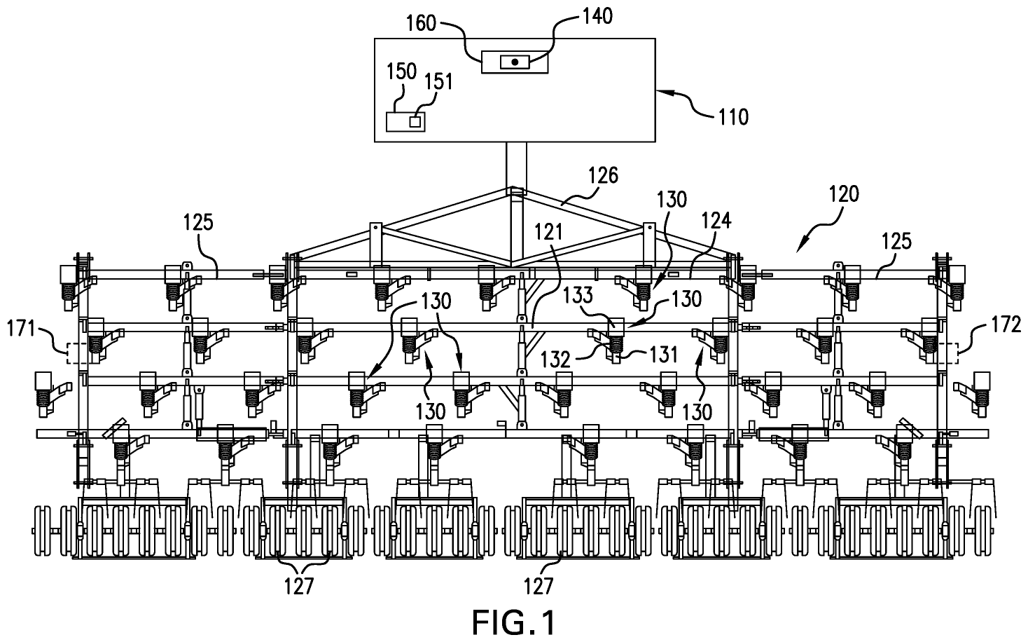

Referring now to the drawings, and more particularly to FIG. 1, an exemplary embodiment of a towing vehicle 110, illustrated generically as a rectangular box, is illustrated towing an agricultural implement 120 formed in accordance with the present disclosure. The towing vehicle 110 may be any suitable vehicle for towing the implement 120 such as, for example, an agricultural tractor. The implement 120, which may be referred to as a “seeder,” includes a frame 121 which carries a plurality of shank assemblies 130, illustrated as knife seeders. As illustrated, the frame 121 carries thirty-five knife seeders 130 in four rows, but it should be appreciated that the number of shank assemblies 130 carried by the frame 121 may be greater or less than thirty-five and the shank assemblies 130 do not need to be carried in separate rows. The frame 121 has a center frame section 124, and two hinged wings 125. The wings 125 can be folded upwards for road-transport and storage of the implement 120. The center frame section 124 includes a hitch 126 that connects the implement 120 to the tractor 110.

Some of the knife seeders 130, as illustrated, slope to the left, and some to the right. Thus, there is no, or only a small, net sideways force on the implement 120. The left seeders and the right seeders are kept separate, in banks, since the configuration of the seeders is not configured for close-pitched left-right mountings thereof.

Press-wheels 127 may be provided, one in-line behind each seeder 130, to roll over and to close the ground after the seeds have been deposited by the seeders 130. The seeders 130 each include a shank 131, which is suspended from the frame 121 of the implement 120. A ground working tool, such as a knife, may be mounted to each shank 131. The suspension mechanism may include a break-back-spring mounting 132. Each of the seeders 130 also includes a trip sensor 133 associated with the shank 131. As used herein, the trip sensors 133 are “associated with” the shanks 131 in the sense that the trip sensors 133 are each coupled to a respective shank 131, directly or indirectly, to detect when the shank 131 collides with an object in a field, such as a rock. When the associated shank 131 collides with an object, the trip sensor 133 may output a trip signal, as will be described further herein. In some embodiments, the trip sensors 133 are each coupled to a trip element, such as a shear bolt, that connects to the shank 131 and allows the shank 131 to be pulled from the ground after the shank 131 collides with an object that triggers the trip element. In some embodiments, the trip sensors 133 are, for example, load sensors coupled to the shanks 131 that measure resistive loads applied to the shanks 131, which can indicate when a shank has collided with an object, such as a rock. It should thus be appreciated that the trip sensors 133 may each be associated with a respective shank in a variety of ways to output a trip signal when the shank collides with an object.

The implement 120 also includes a location sensor 140, which may be a global positioning satellite (GPS) sensor, that is coupled to the frame 121. In some embodiments, such as the embodiment illustrated in FIG. 1, the location sensor 140 is carried by the towing vehicle 110, such as a tractor, and couples to the frame 121 via the hitch 126. In some embodiments, the location sensor 140 is carried by the frame 121. Thus, it should be appreciated that the location sensor 140 is “coupled” to the frame 121 in the sense that the frame 121 and the location sensor 140 move together, but it is not necessary that the location sensor 140 be directly attached to and/or carried by the frame 121.

A controller 150 is operatively coupled to a memory 151, the location sensor 140, and the trip sensors 133 of the shank assemblies 130. As used herein, the controller 150 is “operatively coupled” to the respective components in the sense that the controller 150 is connected by wires or wirelessly, directly or indirectly, to the components to electronically communicate with the components. For example, the controller 150 may be operatively coupled to the memory 151, the location sensor 140, and the trip sensors 133 by wires extending between the controller 150 and the respective elements. The wires from the trip sensors 133 to the controller 150 may extend, for example, along the frame 121 and the hitch 126 to the controller 150, which may be carried by the tractor 110. The controller 150 may be any type of electronic device that can receive electronic signals and perform various functions, as will be described further herein, such as an electrical processing circuit. In some embodiments, the controller 150 is located remotely from the tractor 110 and the implement 120 to, for example, remotely monitor and/or control various functions of the tractor 110 and the implement 120.

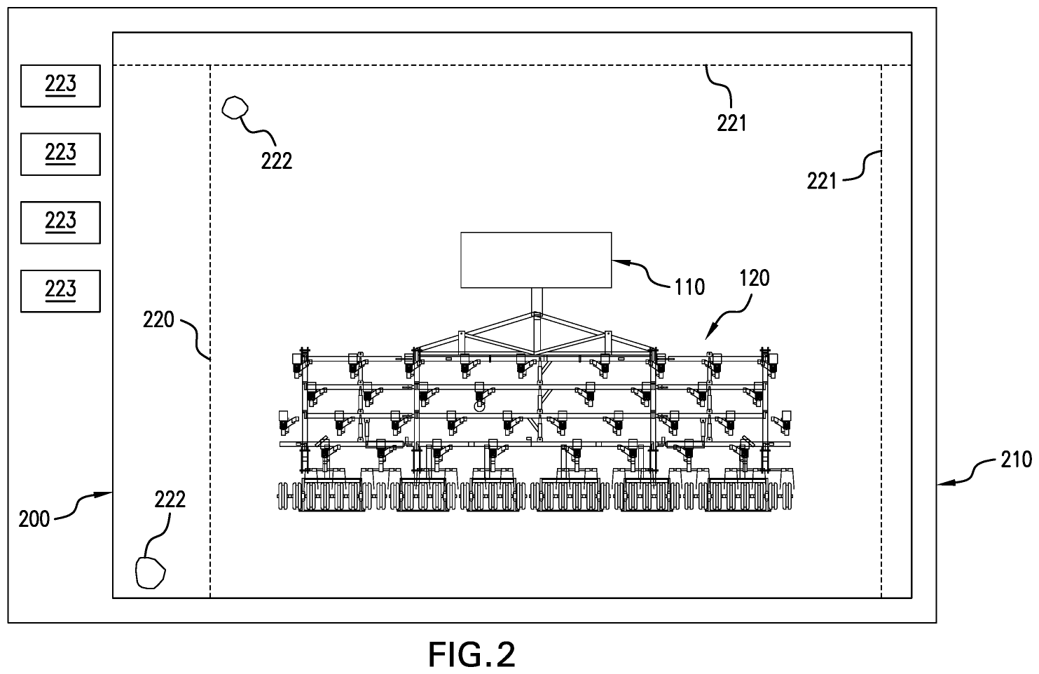

Referring now to FIG. 2, a field map 200 is illustrated that may be stored in the memory 151 operatively coupled to the controller 150. In some embodiments, the field map 200 is displayed on a display device, such as a touchscreen 210, that is operatively coupled to the controller 150 and located within an operating cab 160 (illustrated in FIG. 1) of the tractor 110. The field map 200 may be, for example, a topographical view of a field on which the tractor 110 is pulling the implement 120 and show various things of interest. For example, the displayed field map 200 may include a previously traveled path 220 of the tractor 110, property boundary lines 221 of the field, and various objects that are in the field, such as rocks 222. The field map 200 thus provides an operator with a representation of the field that may be used to control operation of the tractor 110 and the implement 120. The touchscreen 210 may display the stored field map 200 in a graphical user interface (GUI) that also displays, for example, various control buttons 223 that may be used to control how the field map 200 is displayed and/or activate other functions of the controller 150.

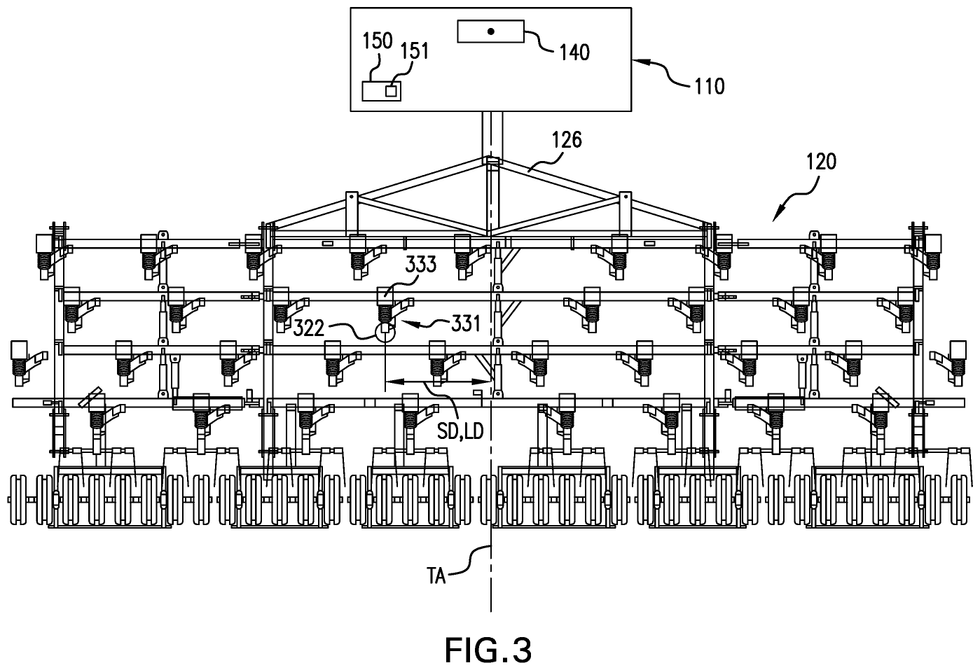

Referring now to FIG. 3, the implement 120 is illustrated with one of the shanks, designated as shank 331, colliding with an object, illustrated as a rock 322. When the shank 331 collides with the rock 322, an associated trip sensor, designated as trip sensor 333, outputs a trip signal, which is received by the controller 150. Upon receiving the trip signal, the controller 150 determines what specific shank, in this instance the shank 331, is associated with the trip sensor that output the trip signal, which is trip sensor 333. To allow the controller 150 to determine the specific shank, each trip sensor may, for example, output a unique trip signal that includes information about what specific trip sensor output the signal, and thus what specific shank is associated with the trip sensor that output the trip signal.

Once the controller 150 has determined what specific shank 331 is associated with the trip sensor 333 that output the trip signal, the controller 150 determines one or more separation distances, illustrated as distance SD, between the specific shank 331 and a reference. In some embodiments, the reference is an axis, such as a travel axis TA defined through the hitch 126. The travel axis TA, which may define a centerline of the frame 121, is the axis on which the implement 120 generally travels when being pulled by the tractor 110. When the reference is the centerline TA of the frame 121, the separation distance SD is generally a lateral distance LD between the centerline TA and the specific shank 331.

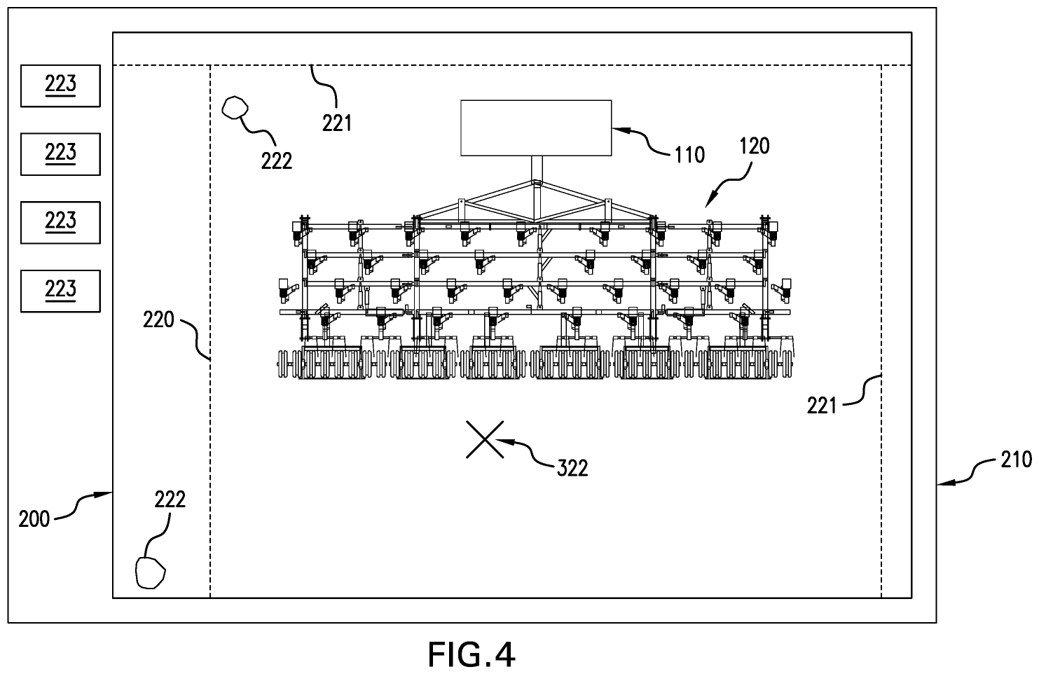

The controller 150 also determines a current location, such as a current location of the location sensor 140, based on the current location signal from the location sensor 140. Once the controller 150 has determined the separation distance SD and the current location, the controller 150 determines a field object location, which indicates a location of the rock 322, based on the determined separation distance SD and the determined current location. For example, the controller 150 may determine that the separation distance SD between the specific shank 331 and the travel axis TA occurred at a certain location in the field map 200 corresponding to the current location and add the separation distance SD to the current location to determine the field object location. The field object location may be determined as, for example, a set of GPS coordinates. The controller 150 may then output an update signal to the memory 151 to designate the field object location in the stored field map, which is illustrated in FIG. 4 with the field object location designated by the X on the field map 200. By updating the field map 200 to designate the field object location X, an operator may avoid future collisions with the object 322 and/or later return to the location of the object 322 to remove the object 322 from the field.

In some embodiments, the field object location X is a field object region where the object 322 may be located. Designating the field object location X as a field object region may be useful when, for example, the object that collided with the shank 331 is an area of heavily compacted soil, which may also be referred to as “hardpan.” By designating the field object location X as a field object region, an operator can know where to return with an implement to break apart the hardpan for future planting. The controller 150 may be configured to designate the field object location X as a field object region when, for example, the controller 150 receives trip signals from a plurality of trip sensors 133 that are spatially close to one another, indicating that multiple shanks 131 collided with the same large object or there is a region in the field with multiple objects and/or hardpan.

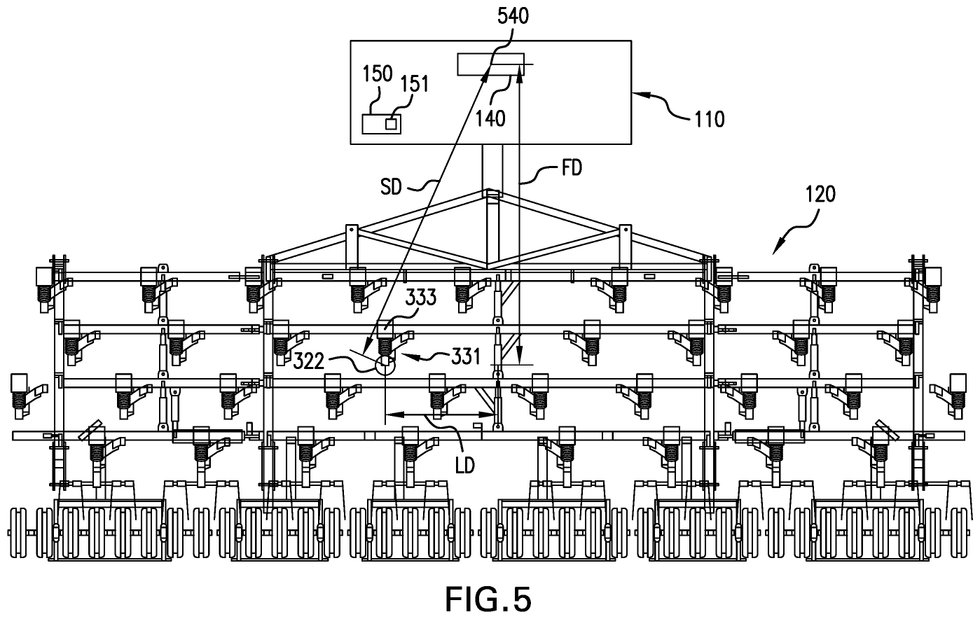

In some embodiments, and referring now to FIG. 5, the reference is a reference point, such as a point 540 at the location sensor 140. When the reference is a reference point 540, a separation distance SD between the specific shank 331 and the reference point 540 may have a lateral distance LD component and a fore-aft distance FD component. It should be appreciated that, in some arrangements, the separation distance SD may be equal to the lateral distance LD or the fore-aft distance FD. After the controller 150 determines the separation distance SD and the current location, such as the current location of the location sensor 140, the controller 150 can determine the field object location based on the separation distance SD of the specific shank 331 from the reference point 540 and output an update signal to the memory 151 to designate the field objection location on the stored field map 200. Such a determination of the field object location may be useful when, for example, the specific shank 331 collides with a simple object, such as a rock or tree stump, rather than a hardpan layer.

The controller 150 may determine the separation distance SD in a variety of ways. In some embodiments, the controller 150 receives the trip signal from the trip sensor 332 associated with the specific shank 331 and identifies the specific shank 331 from information in the trip signal. Once the specific shank 331 is identified, the controller 150 may receive a stored separation distance that is stored in the memory 151, or elsewhere, and corresponds to the separation distance SD between the specific shank 331 and the reference TA, 540. For example, the controller 150 may receive the trip signal from the associated trip sensor 332 to determine that the specific shank 331, which may be identified as “Shank No. 13” in a memory, such as the memory 151, is Shank No. 13 for separation distance purposes. The controller 150 may then send a query signal to the memory 151 (or a different memory) to request the stored separation distance of Shank No. 13, which may be stored in a database of the memory 151, or elsewhere. The controller 150 may then receive a stored separation distance signal that conveys the separation distance SD, e.g., 9.0 meters rearward in the fore-aft distance FD and 3.0 meters left in the lateral distance LD. Based on this received stored separation distance, the controller 150 may then determine the field object location and output the update signal to the memory 151. It should thus be appreciated that each shank 131 may be designated as a specific shank in a database with an associated stored separation distance that the controller 150 may receive to determine the separation distance SD between the specific shank and the reference.

In some embodiments, each of the trip sensors 133 also includes a location module that can sense a current location of the trip sensor 133 using, for example, GPS, and output a current location signal. In such an embodiment, the controller 150 can receive the current location signal from the trip sensor 133 to determine the separation distance SD based on the current location of the trip sensor 133 relative to the reference.

In some embodiments, the frame 121 carries a pair of location sensors 171, 172, which may be GPS sensors and are illustrated as dashed lines in FIG. 1, on opposite lateral ends 173A, 173B of the frame 121. The controller 150 is operatively coupled to the location sensors 171, 172 to receive current location signals from the location sensors 171, 172. When the controller 150 receives an output trip signal, the controller 150 can receive the current location signals from the location sensors 171, 172 to determine a current location. The controller 150 can then determine a field object location based on separation distances between the specific shank and the location sensors 171, 172, which act as the references, and mathematically interpolating the location of the specific shank. The controller 150 can then output the update signal to the memory 151 to designate the field object location on the stored field map 200.

In some embodiments, the controller 150 is configured to take other factors into account other than received location signals and separation distances to determine the field object location. For example, when the tractor 110 is pulling the implement 120, there might be a slight delay between the controller 150 receiving the various signals to determine the field object location. During the delay, the tractor 110 may pull the implement 120 several meters, depending on the delay and the travel speed of the tractor 110 and the implement 120. The controller 150 can be configured to receive a travel speed signal indicative of the travel speed of the tractor 110 and the implement 120 and take the travel speed into account when determining the field object location. The controller 150 may, for example, be configured to multiply the sensed travel speed by a stored time delay multiplier to determine a traveled distance during the delay. The controller 150 may then take the traveled distance during the delay into account when determining the field object location.

In some embodiments, the controller 150 is configured to determine a likelihood that the specific shank 331 collided with a damaging object, such as a large rock or tree roots, and only output the update signal if the determined likelihood is greater than a threshold likelihood. For example, when the trip sensor 332 associated with the specific shank 331 is a load sensor, the controller 150 can be configured to analyze the received trip signal and determine various collision characteristics. Exemplary collision characteristics include, but are not limited to, a magnitude of the load exerted on the specific shank 331 during the collision, a time period of the collision, and a previous load profile on the specific shank 331. For example, a sudden, relatively high load exerted on the specific shank 331 may be indicative of a large, immobile object, such as a large rock, that is likely to cause damage to shanks. If the controller 150 determines, based on the calculations, that the likelihood that the collision was with such an object, the controller 150 may then output the update signal to the memory 151 to update the stored field map 200. Exemplary threshold likelihoods may be, but are not limited to, at least a 30% likelihood that the collision was between the specific shank 331 and a damaging object. If the controller 150 determines the likelihood as being below the threshold, e.g., less than 30%, the controller 150 may send a warning signal to the touchscreen 210 to issue a warning message, but not designate the field object location in the stored field map 200 without additional input from, for example, an operator.

From the foregoing, it should be appreciated that the controller 150 is configured to accurately update a stored field map to designate field objects in a field. Known controllers that mark field objects in field maps generally do so by marking a current location of the implement where the trip sensor outputs a trip signal. While this gives an operator a general idea of where a field object may be located in a field, many implements are quite large so the object may be in an area that is hundreds of square meters. The controller 150 provided in accordance with the present disclosure, on the other hand, can accurately determine where a field object is in a field based on a separation distance between the specific shank associated with the trip sensor that output the trip signal and a reference, as well as a current location. Upon determining where the object is located in the field, the controller 150 can automatically output an update signal to update a stored field map 200 to alert an operator where the object is located. Thus, the controller 150 provided in accordance with the present disclosure can accurately designate where a field object is located in a field and automatically designate the object in a stored field map. Further, the controller 150 can determine a likelihood that a collision between a shank and an object is likely to be one that presents a significant risk of shank damage. If a future collision between a shank and the encountered object is unlikely to cause damage to the shank, the controller 150 may issue a warning but not update the stored field map so insignificant objects, such as small rocks, are not marked on the field map.

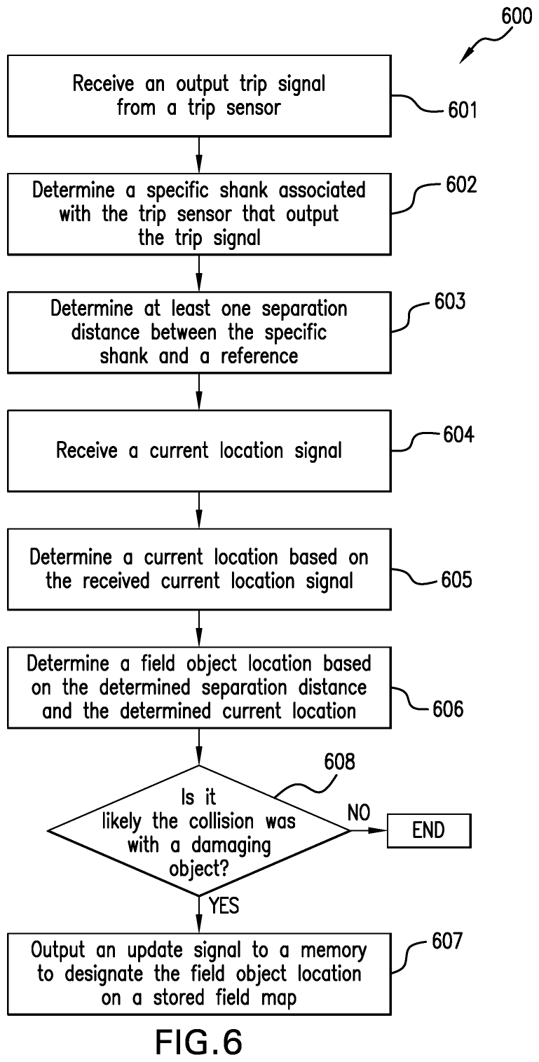

Referring now to FIG. 6, an exemplary embodiment of a method 600 of updating a field map 200 stored in a memory 151 is illustrated. The method 600 is performed by a controller, such as the previously described controller 150. The controller 150 receives 601 an output trip signal from a trip sensor 132 that is output when an associated shank 131 of an agricultural implement 120 collides with an object, such as a rock. The controller 150 determines 602 a specific shank 331 associated with the trip sensor 332 that output the trip signal and determines 603 at least one separation distance SD between the specific shank 331 and a reference, which may be a travel axis and/or a centerline TA of a frame 121 of the implement 120 or a reference point 540 of the frame 121. In some embodiments, the controller 150 determines 603 the at least one separation distance SD by receiving a stored separation distance between the specific shank 331 and the reference TA, 540 from, for example, a database stored in the memory 151 or elsewhere. The controller 150 receives 604 a current location signal from a location sensor 140, which may be a GPS sensor carried by a towing vehicle 110 or the implement 120, and determines 605 a current location based on the received current location signal. The controller 150 determines 606 a field object location X based on the determined separation distance(s) SD and the determined current location and outputs 607 an update signal to the memory 151 to designate the field object location X, which may be designated as a field object region, on the stored field map 200. In some embodiments, the separation distance SD includes a lateral distance LD and/or a fore-aft distance FD. In some embodiments, the controller 150 analyzes 608 the trip signal to determine a likelihood that the specific shank 331 collided with a damaging object and only outputs 607 the update signal if the likelihood is greater than a threshold likelihood.

It is to be understood that, in some embodiments, the steps of the method 600 are performed by the controller 150 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 150 described herein, such as the method 600, is implemented in software code or instructions which are tangibly stored on a tangible computer readable medium. The controller 150 loads the software code or instructions via a direct interface with the computer readable medium or via a wired and/or wireless network. Upon loading and executing such software code or instructions by the controller 150, the controller 150 may perform any of the functionality of the controller 150 described herein, including any steps of the method 600 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural implement, comprising:
a frame;
a location sensor coupled with the frame and configured to output a current location signal;
a plurality of shank assemblies carried by the frame, each of the shank assemblies comprising:
a shank; and
a trip sensor associated with the shank and configured to output a trip signal when the shank collides with an object; and
a controller operatively coupled to a memory storing a field map therein, the location sensor, and the trip sensor of each of the shank assemblies, the controller being configured to:
receive the output trip signal from the trip sensor of at least one of the shank assemblies;
determine a specific shank associated with the trip sensor that output the trip signal;
determine at least one separation distance between the specific shank and a reference;
determine a current location based on the current location signal;
determine a field object location based on the determined at least one separation distance and the determined current location; and
output an update signal to the memory to designate the field object location on the stored field map.

2. The agricultural implement of claim 1, wherein the frame defines a travel axis therethrough, the reference being the travel axis.

3. The agricultural implement of claim 2, wherein the travel axis is a centerline of the frame.

4. The agricultural implement of claim 3, wherein the at least one separation distance comprises a lateral distance between the centerline and the specific shank.

5. The agricultural implement of claim 1, wherein the reference is a reference point of the frame.

6. The agricultural implement of claim 5, wherein the at least one separation distance comprises a lateral distance and a fore-aft distance between the reference point and the specific shank.

7. The agricultural implement of claim 1, wherein the controller is further configured to:
analyze the trip signal to determine a likelihood that the specific shank collided with a damaging object, wherein the controller is configured to only output the update signal if the likelihood is greater than a threshold likelihood.

8. The agricultural implement of claim 1, wherein the controller is configured to designate the field object location on the stored field map as a field object region.

9. The agricultural implement of claim 1, wherein the location sensor is a global positioning satellite (GPS) sensor.

10. The agricultural implement of claim 1, wherein the controller is configured to determine the at least one separation distance by receiving a stored separation distance between the specific shank and the reference.

11. A method of updating a field map stored in a memory, the method being performed by a controller and comprising:
receiving an output trip signal from a trip sensor associated with at least one shank of an agricultural implement, the trip signal being output when the at least one shank collides with an object;
determining a specific shank associated with the trip sensor that output the trip signal;
determining at least one separation distance between the specific shank and a reference;
receiving a current location signal from a location sensor;
determining a current location based on the received current location signal;
determining a field object location based on the determined at least one separation distance and the determined current location; and
outputting an update signal to the memory to designate the field object location on the stored field map.

12. The method of claim 11, wherein the agricultural implement comprises a frame defining a travel axis therethrough, the reference being the travel axis.

13. The method of claim 12, wherein the travel axis is a centerline of the frame.

14. The method of claim 13, wherein the at least one separation distance comprises a lateral distance between the centerline and the specific shank.

15. The method of claim 11, wherein the agricultural implement comprises a frame and the reference is a reference point of the frame.

16. The method of claim 15, wherein the at least one separation distance comprises a lateral distance and a fore-aft distance between the reference point and the specific shank.

17. The method of claim 11, further comprising:
analyzing the trip signal to determine a likelihood that the specific shank collided with a damaging object, wherein the update signal is only output if the likelihood is greater than a threshold likelihood.

18. The method of claim 11, wherein the field object location is designated on the stored field map as a field object region.

19. The method of claim 11, wherein the location sensor is a global positioning satellite (GPS) sensor.

20. The method of claim 11, wherein determining the at least one separation distance comprises receiving a stored separation distance between the specific shank and the reference.
